(19) United States
(12) Patent Application Publication
(10) Pub. No.: US 2010/0014201 A1
(43) Pub. Date: Jan. 21, 2010

(54) LOGIC OUTPUT STAGE OF INTEGRATED CIRCUIT PROTECTED AGAINST BATTERY INVERSION

(75) Inventors: Thierry Masson, Varces (FR); Pierre Coquille, Theoffrey (FR)

Correspondence Address: LOWE HAUPTMAN HAM & BERNER, LLP, 1700 DIAGONAL ROAD, SUITE 300, ALEXANDRIA, VA, 22314, US

(73) Assignee: E2V SEMICONDUCTORS, Saint Egreve (FR)

(21) Appl. No.: 12/447,835

(22) PCT Filed: Oct. 31, 2007
(86) PCT No.: PCT/EP2007/061740

§ 371 Date: Jun. 3, 2009

(30) Foreign Application Priority Data
Nov. 10, 2006 (FR) 06 09842

(51) Int. Cl. H02H 3/00

(52) U.S. Cl. 361/84

(57) ABSTRACT

The invention relates to integrated electronic circuits in MOS technology that have to be supplied by a cell or a battery that have a relatively high voltage capable of destroying the circuit in the event of a battery connection error, most particularly when a negative voltage is connected to an output of the integrated circuit. The logic output stage connected to this output comprises two pMOS transistors in series operating in push-pull mode under the control of the logic input signal, a first transistor being connected to a high supply terminal of the integrated circuit and the second transistor to a low supply terminal; the output is taken at the junction point of the two transistors. A conduction control circuit, capable of applying a negative voltage relative to the low supply terminal to the gate of the second transistor when the logic input signal passes to a level tending to turn off the first transistor, is interposed between the input and the gate of the second transistor.

### CROSS-REFERENCE TO RELATED APPLICATIONS

The present Application is based on International Application No. PCT/EP2007/061740, filed on Oct. 31, 2007, which in turn corresponds to French Application No. 0609842, filed on Nov. 10, 2006, and priority is hereby claimed under 35 USC §119 based on these applications. Each of these applications are hereby incorporated by reference in their entirety into the present application.

### FIELD OF THE INVENTION

The invention relates to integrated electronic circuits in MOS technology, which have to be supplied by a cell or a battery possibly having a relatively high voltage liable to destroy the circuit in the event of a battery connection error. The error envisioned here is notably an unfortunate connection of a negative voltage to an output of the integrated circuit, the substrate of which is at a more positive potential (for example a ground reference).

### BACKGROUND OF THE INVENTION

To give an example in automotive applications the conventional supply voltage is delivered by a 12 volt battery, this being permanently recharged through a regulator. In the event of a battery connection error in the vehicle (the connection of the negative terminal to an integrated-circuit output not intended to receive this connection), at worst it may be acceptable for the various electronic installations no longer to operate, but it is unacceptable for them to be destroyed. Not only is it desirable for them to withstand −12 volts, but even, for safety, −16 volts (typically).

A logic output terminal usually comprises a push-pull output stage, comprising a pMOS transistor and an nMOS transistor in series, the output of the stage being connected to the junction point of the two transistors. The term-push-pull stage “is understood to mean an arrangement of two transistors is series between the supply terminals, one of the transistors being in the on-state while the other is in the off-state, and visa versa, depending on the logic state at the input of the stage.

In this type of stage, the output is therefore connected to the drain of the n-channel MOS transistor. However, this drain is an n-doped semiconductor region which forms, with the p-type substrate (or with a p-type well at the potential of the substrate), an n-p junction.

This junction becomes forward-biased if a negative supply voltage is erroneously applied to the output, whereas the substrate is at a more positive (zero) voltage. The junction breaks down and destroys the integrated circuit.

The existing solutions for preventing this risk essentially consist in providing a diode in series with the logic output, in the inverse sense of the abovementioned junction. This diode prevents a reverse current from flowing in the event of an unfortunate connection of the negative terminal of the battery to this input. However, this diode is not easy to integrate into the substrate of the integrated circuit and, in addition, it introduces a voltage drop of about 0.7 volts in the output connection under normal operation, this being problematic when the output has to be at a logic low level. Furthermore, it must bias the diode in the forward direction in order to be certain that it does not introduce an even higher voltage drop, hence an undesirable consumption of current.

It has also been proposed to use not a diode in series but a resistor in series. The same drawbacks remain—for example, with a nominal output current of 10 mA and a current-limiting resistor of at least 50 ohms (to avoid destroying the junction in the event of a wrong connection), a voltage drop of 0.5 volts occurs in normal operation, degrading the logic low level that the output of the integrated circuit can deliver.

### SUMMARY OF THE INVENTION

To solve this problem, the invention proposes to modify the output stage in order to replace the series combination of an nMOS transistor and a pMOS transistor by a series combination of two pMOS transistors controlled by inverse logic levels, the pMOS transistor connected to the lowest potential of the supply having its gate controlled by a circuit (a kind of charge pump) delivering a voltage lower than the lowest potential when the transistor has to be in the on-state.

In other words, the proposed invention is a logic output stage of an integrated circuit in CMOS technology, comprising an input for a logic input signal, two transistors in series operating in push-pull mode under the control of the logic input signal, a first transistor being connected to a high supply terminal of the integrated circuit and the second transistor being connected to a low supply terminal, and an output connected to the junction point of the two transistors, characterized in that the two transistors are pMOS transistors and in that a conduction control circuit, capable of applying a negative voltage with respect to the low supply terminal to the gate of the second transistor when the logic input signal goes to a level tending to turn off the first transistor, is interposed between the input and the gate of the second transistor.

Preferably, the conduction control circuit comprises third and fourth pMOS transistors in series, the third transistor being connected to the high supply terminal and the fourth transistor to the low supply terminal, and the junction point of the third and fourth transistors being connected to the gate of the second transistor, the gate of the fourth transistor being controlled by a logic signal the inverse of the input signal, the circuit further including a capacitor a first terminal of which is connected to the junction point of the third and fourth transistors and a second terminal receives a signal corresponding to the control signal for the fourth transistor, which signal is delayed by a delay component.

Preferably, provision is made for a fifth pMOS transistor to be placed in parallel with the second transistor, the gate of the fifth transistor being controlled by a second conduction control circuit identical to the first, the two circuits being actuated alternately under the control of a clock that permits the operation of one of them while it prevents the operation of the other, and vice versa.

Advantageously, the second and fifth transistors are placed in one and the same well of opposite type to the substrate of the integrated circuit.

In an improvement, the second transistor is placed in an n-type well, the potential of which is fixed, by a well biasing circuit, to the value of the potential of the output if this potential is positive relative to the substrate and to a potential value close to that of the substrate if a negative potential relative to the substrate is applied to the output.

The output stage according to the invention is particularly advantageous when the output is connected directly to an external connection terminal of the integrated circuit.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 shows the starting principle of an output stage according to the present invention;

FIG. 2 shows the output stage with its conduction control circuit;

FIG. 3 shows the output stage with the conduction control circuit in detail;

FIG. 4 shows the timing diagram for the signals of the circuit of FIG. 3;

FIG. 5 illustrates the timing diagram in the case in which the input remains for a long time at the high level;

FIG. 6 shows a modification of the output stage for allowing the input to remain for a long time at the high level;

FIG. 7 show a timing diagram of the circuit of FIG. 6; and

FIG. 8 shows a circuit for biasing the well of the second transistor of the push-pull combination connected to the output.

### DETAILED DESCRIPTION OF THE INVENTION

FIG. 1 shows in simplified form the basic principle of a logic output stage according to the invention.

The integrated circuit itself, with its various functionalities, has not been shown and it is assumed that it has to deliver a logic signal Vₒᵤₜ to an external output terminal B, said logic signal being of high or low level depending on whether the logic signal Vᵢₙ that this stage receives on its input E is of low or high level.

The output stage comprises two pMOS transistors T1 and T2 in series between the high and low supply terminals, A and G, of the integrated circuit. These terminals are intended to receive, respectively, a zero reference potential (terminal G) and a positive supply potential V_{dd} (terminal A), for example 12 volts in an automotive application. The transistors are mounted in push-pull logic configuration in that one of the two transistors is controlled so as to be conducting while the other is controlled so as to be non conducting, and visa versa. The source of the transistor T1 is at the high supply potential V_{dd}; the drain of T1 and the source of T2 are both connected to the output terminal B, so as to deliver an output signal Vₒᵤₜ; and the drain of T2 is connected to the low supply potential (ground G).

The input E of the stage is connected directly to the gate of the transistor T1 and connected via an inverter I1 to the gate of the transistor T2.

When the input signal Vᵢₙ is at the low level (the potential of G), the transistor T1 is in the on-state and the transistor T2 is in the off-state; the output delivers a logic high level Vₒᵤₜ (at the potential V_{dd} of A.). Conversely, if the input signal Vᵢₙ is at the high level, it is the transistor T2 which is in the on-state and the transistor T1 is in the off-state; the output delivers a logic low level Vₒᵤₜ (potential of G).

However, the logic low level thus obtained is not a good low level. By taking the gate of the transistor T2 to ground G, it is barely possible for the output voltage Vₒᵤₜ to fall below about one volt, because of the threshold voltage that must necessarily be applied between the gate and source in order to turn on the transistor T2. Now, correct operation of the circuits connected downstream of the output terminal B may require that the logic low level delivered on this terminal really be a low level (very close to zero) and not a level of 1 or 1.5 volts.

This is why provision is made for the transistor at the lowest potential (T2) to have its gate controlled by a circuit capable of lowering the gate potential below the potential of the lowest supply terminal when this transistor has to be turned on.

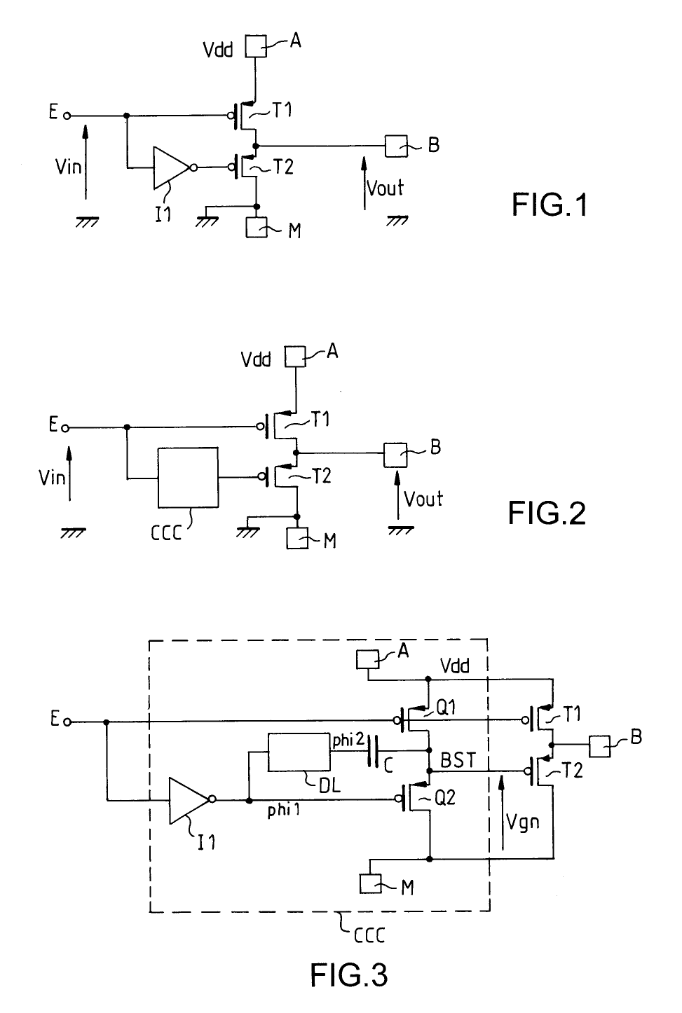

The circuit of FIG. 2 shows this principle schematically. The simple inverter of FIG. 1 has been replaced by a conduction control circuit CCC having the following functions:
upon receiving a logic low signal on the input E, it turns off the transistor T2 by applying a voltage equal to the supply voltage V_{dd} to its gate;
upon receiving a logic high signal on its input E, it turns the transistor T2 plainly on, by applying a more negative voltage than the potential of the ground supply terminal G to its gate.

FIG. 3 shows an example of a conduction control circuit CCC fulfilling these functions. This circuit comprises:
a push-pull arrangement of two pMOS transistors Q1 and Q2, mounted in series like the transistors T1 and T2 between the supply terminals A and G (source of Q1 at V_{dd} and drain of Q2 at ground G); the gate of the transistor Q1 is directly controlled by the input E; the gate of the transistor Q2 is controlled by an inverter I1, the input of which is connected to the input E;
a delay circuit DL for delaying the falling edge presented at the output of the inverter; and
a capacitor C connected between the output of the delay circuit and the output BST of the conduction control circuit CCC; this output of the control circuit is the output of the push-pull stage Q1, Q2, taken on the drain of Q1 connected to the source of Q2.

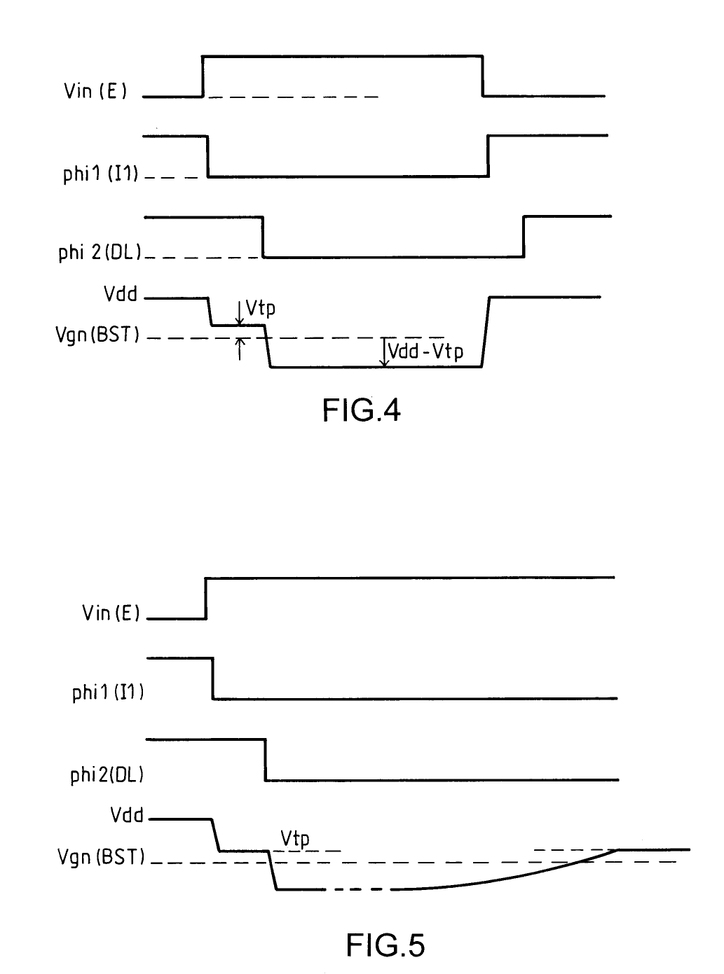

This conduction control circuit CCC, which may be called a “charge pump” circuit, operates in the following manner, as explained with reference to the signal timing diagram of FIG. 4.

When the input E is at the low level, the transistor T1 is in the on-state and the transistor T2 is in the off-state because of the high state of the signal phi1 at the output of the inverter I1. The output BST is at the high level V_{dd}.

When the logic rising edge, going from the low level to the high level, arises on the input E (first line of the timing diagram), the transistor Q1 is turned off; the signal phi1 drops to zero (second line of the timing diagram), this signal phi1 applied to the gate of the transistor Q2 tending to turn the latter on; the potential V_{gn} on the output BST of the circuit drops down to a value Vₜₕ close to the threshold voltage of the transistor T2 (see the fourth line of the timing diagram), this potential not being able to drop lower through the sole effect of the output of the inverter I1.

A signal phi2 is generated from the signal phi1, phi2 being identical to phi1 but delayed by the delay circuit DL (third line of the timing diagram), this signal phi2 being applied to the capacitor C; the sudden transition of phi2 to the low level causes the potential at the output BST to drop suddenly, through a simple capacitive effect, the potential at the output BST becoming approximately equal to Vₜₕ−V_{dd} if it is assumed that the amplitude of the signal phi2 is approximately equal to V_{dd}, this being easy to achieve in a logic circuit.

V_{dd} is substantially greater than Vₜₕ so that the potential level on the output BST becomes clearly negative at the falling edge of phi2; the source potential of Q2 becomes more negative than the gate potential; and the transistor Q2 is completely turned off, the transistor Q1 already being turned off. The BST node remains isolated and maintains its negative potential.

It is this output BST that serves to control the gate of the transistor T2 of the output stage. When a rising edge arrives on the input E, a negative voltage Vₜₕ−V_{dd} is thus produced that clearly turns the transistor T2 on through a gate bias more negative than the source.

When a logic edge falling again from the high level to the low level arrives on the input E, the transistor Q1 is turned on, the transistor Q2 is turned off and the output BST returns to V_{dd}; when phi2 rises back to V_{dd}, the capacitor C discharges. It would be conceivable for the delay circuit DL to act as a delay circuit only for falling edges at the output of the inverter I1, but it is simpler to use as delay circuit a pair of inverters, or more generally an even number of inverters, and in such a case action occurs both on the rising edges and on the falling edges.

This circuit is well suited to an operation in which the logic signal on the input E varies dynamically. It has a drawback when the signal on the input E has to be able to statically maintain a high level for quite a long time. This is because leaks from the transistor Q1 run the risk of progressively raising the level of the potential V_{gn} of the output BST, as can be seen in FIG. 5.

FIG. 5 shows the signal timing diagram under this assumption, in which the input signal remains statically at the high level for a sufficiently long time for the output potential V_{gn} to start to change. As may be seen, this potential rises toward the zero level and then exceeds it, stabilizing at around Vₜₕ. It does not rise beyond Vₜₕ since, when it reaches Vₜₕ, the transistor T2, which has its gate at ground potential, is in the on-state and keeps the output close to Vₜₕ.

When it is at Vₜₕ, or even at a lower value, it is clear that the conduction control circuit no longer fulfils its function, since the voltage on the output terminal B will be close to 2Vₜₕ instead of being clearly zero (assuming that the transistors Q1 and T1 have the same threshold voltage Vₜₕ).

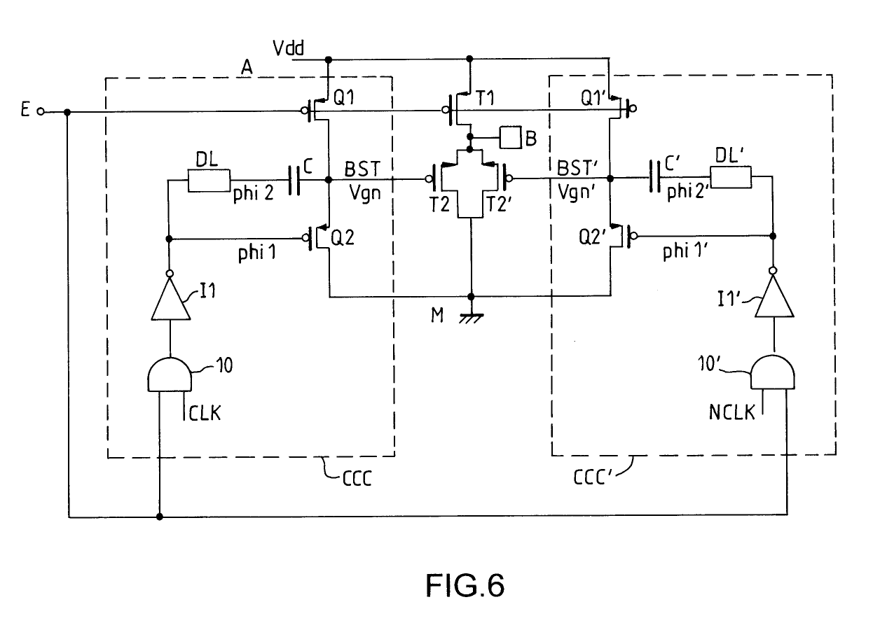

An improvement according to the invention is shown in FIG. 6. This improvement consists in providing a second transistor T′2 in parallel with the transistor T2, with a conduction control circuit CCC′ for the transistor T2′, identical to the circuit CCC but controlled alternately with it under the control of a clock. During a clock pulse CLK, it is the circuit CCC that acts on the transistor T2, while during the next complementary pulse NCLK, it is the circuit CCC′ that acts on the transistor T2′. The edges of the clock are used for capacitively lowering the output potential V_{gn} or V_{gn}′ at the two circuits CCC and CCC′.

Thus, alternately at the clock rate, the transistor T2 and then the transistor T2′ will be clearly turned on, so that even if the potential V_{gn} tends to rise at the output of the CCC circuit, it will not have time to do so before the output potential V_{gn}′ of the circuit CCC′ experiences a new pulse giving it a negative value.

The output falling edges of the delay component DL may be triggered by the rising and falling edges of the clock.

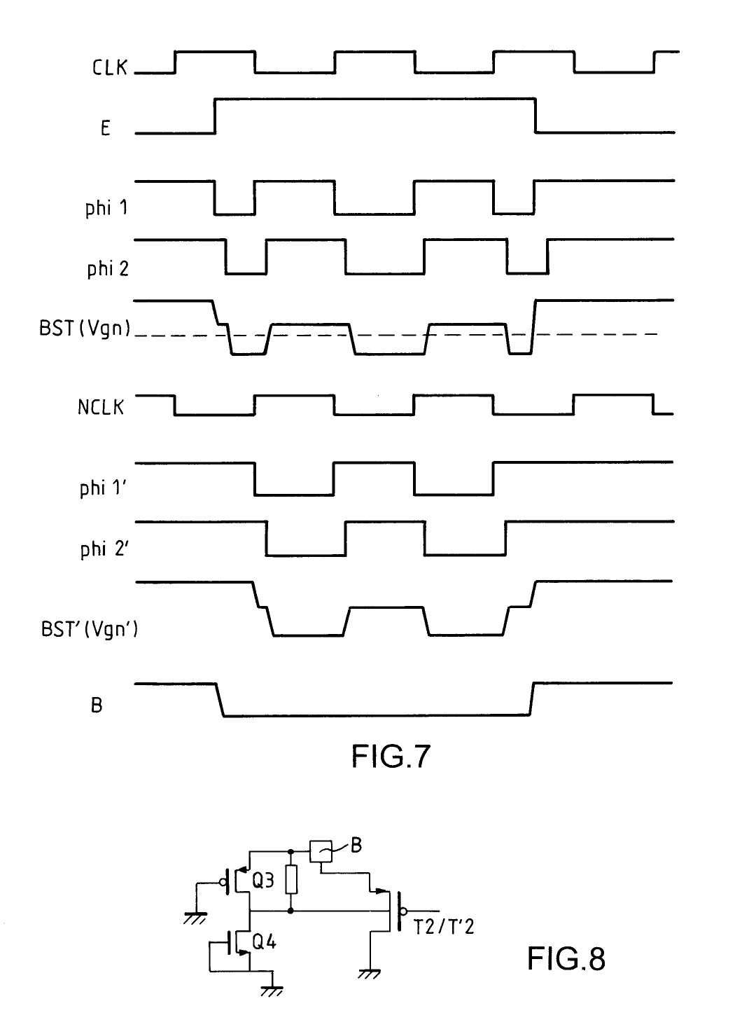

FIG. 6 shows an exemplary embodiment of the circuit and FIG. 7 shows the associated signal timing diagram.

The input E remains connected directly to the gate of the transistor T1 and is also connected directly to the gates of the transistors Q1 and Q′1 of the identical circuits CCC and CCC′. The circuits CCC and CCC′ are modified in relation to FIG. 3 in that they each include a logic AND gate, denoted respectively by 10 and 10′, one input of which is connected to the input E and the other input of which receives the clock signal CLK in respect of the gate 10 and the complement NCLK of the clock signal in respect of the gate 10′. The circuits CCC and CCC′ function alternatively at each clock pulse when the input level E is high. They are inert with respect to the clock, i.e. simply play the role of inverting the input signal E when the input level is low.

When the input level is high, the signal phi1 reproduces the clock signal CLK, by inverting it; the signal phi1′ reproduces the complement NCLK of the signal CLK, by inverting it. The signals phi2 and phi2′ are identical to phi1 and phi1′, but delayed by the delay components DL and DL′. The output voltage V_{gn} on the output BST of the circuit CCC drops from V_{dd} to about Vₜₕ at the falling edge of phi1, and then from Vₜₕ to Vₜₕ−V_{dd} at the falling edge of phi2. The transistor T2 becomes clearly conducting and keeps the output B at zero. When phi2 rises back to 1, the output voltage V_{gn} rises back to Vₜₕ and no longer makes the transistor T2 sufficiently conducting, but at the same moment the signal phi2′ passes to Vₜₕ−V_{dd} and makes the transistor T2′ clearly conducting. The output B therefore remains at zero. The transistors T2 and T2′ are alternately turned on and keep the output B at zero until the input E returns to the low level.

If the input E returns to the low level during a high level of the clock CLK, it switches phi1 to 1 (Q2 in the off-state) at the same time that it turns Q1 on. The output BST, which was at Vₜₕ−V_{dd}, therefore switches to V_{dd} and turns off T2 at the same time as the input E switches to the low level. At that moment, the output BST′ being at the level Vₜₕ switches to V_{dd}, also turning off the transistor T2′. The reverse occurs, with the same result, if the input returns to 1 during the low level of the clock CLK.

The transistors T2 and T2′ are in one and the same n-well formed in the substrate of the circuit. The transistor T1 is in a separate well.

To improve the effectiveness of the negative bias on the gate of the transistor T2 (or of the transistors T2 and T2′), it is preferable to raise the well of the transistor T2 (or T2 and T2′) to the potential of the source of T2, and therefore to the output B, thereby preventing the threshold voltage Vₜₕ of this transistor from being dependent on the output level Vₒᵤₜ on the terminal B. This is because the threshold voltage tends to increase when the output level drops, even in the presence of a negative gate voltage. By maintaining the well at the output potential, the drawback is avoided. However, the well cannot be connected directly to the source, by establishing a link between the p-type source and an n-type diffusion formed in the well. If such a direct link were to be made, a path would be established with a single substrate/well diode between the output and the substrate, and, in the event of the negative terminal of the battery being wrongly connected to the output, this diode would switch to forward conduction, something which of course would be desirable to avoid. This is why the well is raised to the potential of the output B by means of a well bias circuit that biases the latter:
to the potential of the output B, if this is positive (normal situation); or
to a potential close that of the substrate, if it is negative (accidental situation).

The well bias circuit of the transistor T2 is shown in FIG. 8. It comprises a pMOS transistor Q3 formed in an n-well separate from the other wells. This transistor has its drain connected to its well, it has its source connected to the output B and it has its gate connected to the substrate. It also includes an nMOS transistor Q4 mounted as a diode, the drain of which is connected to the drain of the transistor Q3, and the source and the gate are connected to the substrate. Finally, a current-limiting resistor, for example a 100 kohm resistor, is connected between the output B and the drains of these two transistors. The drains of the transistors Q3 and Q4 form the output of the bias circuit and are connected to the well of the transistor T2.

If the voltage on the output B changes between 0 (ground potential to which the substrate of the integrated circuit is connected) and a positive value, the transistor Q3 is in the on-state and takes the well of the transistor T2 to Vₒᵤₜ. The transistor Q4 is in the off-state. If the voltage on the output B unfortunately becomes negative relative to the substrate (to ground), the transistor Q3 is turned off and the transistor Q4 becomes conducting (its current being greatly limited by the resistor) and it takes the well of the transistor T2 to a slightly negative potential.

The well of the transistor T1 itself remains at the potential V_{dd} to which its source is raised.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A logic output stage of an integrated circuit in CMOS technology, comprising an input for a logic input signal, two transistors in series operating in push-pull mode under the control of the logic input signal, a first transistor being connected to a high supply terminal of the integrated circuit and the second transistor to a low supply terminal, and an output connected to the junction point of the two transistors, wherein the two transistors are pMOS transistors and the logic output stage comprises a conduction control circuit, capable of applying a negative voltage with respect to the low supply terminal to the gate of the second transistor when the logic input signal goes to a level tending to turn off the first transistor, said conduction control circuit interposed between the input and the gate of the second transistor.

2. The output stage as claimed in claim 1, wherein the conduction control circuit comprises third and fourth pMOS transistors in series, the third transistor being connected to the high supply terminal and the fourth transistor to the low supply terminal, and the junction point of the third and fourth transistors being connected to the gate of the second transistor, the gate of the fourth transistor being controlled by a logic signal the inverse of the input signal, the circuit further including a capacitor a first terminal of which is connected to the junction point of the third and fourth transistors and a second terminal receives a signal which corresponds to the control signal for the fourth transistor, which signal is delayed by a delay component.

3. The output stage as claimed in claim 1, wherein a fifth pMOS transistor is placed in parallel with the second transistor (T2), the gate of the fifth transistor being controlled by a second conduction control circuit identical to the first conduction control circuit, the two conduction control circuits being actuated alternately under the control of a clock that permits the operation of one of them while it prevents the operation of the other, and vice versa.

4. The output stage as claimed in claim 3, wherein the second and fifth transistors are placed in one and the same well of opposite type to the substrate of the integrated circuit.

5. The output stage as claimed in claim 1, wherein the second transistor is placed in an n-type well, the potential of which is fixed to the value of the potential of the source of this transistor if this potential is positive relative to the substrate and to a potential value close to that of the substrate if a negative potential relative to the substrate is applied to the output.

6. The output stage as claimed in claim 5, including a circuit for biasing the well of the second transistor, said circuit comprising a pMOS transistor having its source connected to the output, its gate connected to the substrate, and its drain connected to the well and to the drain of an nMOS transistor having its source and its gate both connected to the substrate, the joined drains of these two transistors being connected to the well of the second transistor.

7. The output stage as claimed in claim 1, wherein the output is an external connection terminal of the integrated circuit.

8. The output stage as claimed in claim 2, wherein a fifth pMOS transistor is placed in parallel with the second transistor, the gate of the fifth transistor being controlled by a second conduction control circuit identical to the first conduction control circuit, the two conduction control circuits being actuated alternately under the control of a clock that permits the operation of one of them while it prevents the operation of the other, and vice versa.

9. The output stage as claimed in claim 8, wherein the second and fifth transistors are placed in one and the same well of opposite type to the substrate of the integrated circuit.

10. The output stage as claimed in claim 2 wherein the second transistor is placed in an n-type well, the potential of which is fixed to the value of the potential of the source of this transistor if this potential is positive relative to the substrate and to a potential value close to that of the substrate if a negative potential relative to the substrate is applied to the output.

11. The output stage as claimed in claim 3 wherein the second transistor is placed in an n-type well, the potential of which is fixed to the value of the potential of the source of this transistor if this potential is positive relative to the substrate and to a potential value close to that of the substrate if a negative potential relative to the substrate is applied to the output.

12. The output stage as claimed in claim 4 wherein the second transistor is placed in an n-type well, the potential of which is fixed to the value of the potential of the source of this transistor if this potential is positive relative to the substrate and to a potential value close to that of the substrate if a negative potential relative to the substrate is applied to the output.

13. The output stage as claimed in claim 10, including a circuit for biasing the well of the second transistor, said circuit comprising a pMOS transistor having its source connected to the output, its gate connected to the substrate, and its drain connected to the well and to the drain of an nMOS transistor having its source and its gate both connected to the substrate, the joined drains of these two transistors being connected to the well of the second transistor.

14. The output stage as claimed in claim 11, including a circuit for biasing the well of the second transistor, said circuit comprising a pMOS transistor having its source connected to the output, its gate connected to the substrate, and its drain connected to the well and to the drain of an nMOS transistor having its source and its gate both connected to the substrate, the joined drains of these two transistors being connected to the well of the second transistor.

15. The output stage as claimed in claim 12, including a circuit for biasing the well of the second transistor, said circuit comprising a pMOS transistor having its source connected to the output, its gate connected to the substrate, and its drain connected to the well and to the drain of an nMOS transistor having its source and its gate both connected to the substrate, the joined drains of these two transistors being connected to the well of the second transistor.

16. The output stage as claimed in claim 2, wherein the output is an external connection terminal of the integrated circuit.

17. The output stage as claimed in claim 3, wherein the output is an external connection terminal of the integrated circuit.

18. The output stage as claimed in claim 4, wherein the output is an external connection terminal of the integrated circuit.

19. The output stage as claimed in claim 5, wherein the output is an external connection terminal of the integrated circuit.

20. The output stage as claimed in claim 6, wherein the output is an external connection terminal of the integrated circuit.
